(19) United States
(12) Patent Application Publication
(10) Pub. No.: US 2019/0308212 A1
(43) Pub. Date: Oct. 10, 2019

(54) PRINT HEAD AND ASSOCIATED OPERATING METHOD

(71) Applicant: Dürr Systems AG, Bietigheim-Bissingen (DE)

(72) Inventors: Hans-Georg Fritz, Ostfildern (DE); Benjamin Wöhr, Eibensbach (DE); Marcus Kleiner, Besigheim (DE); Moritz Bubek, Ludwigsburg (DE); Timo Beyl, Besigheim (DE); Frank Herre, Oberriexingen (DE); Steffen Sotzny, Oberstenfeld (DE)

(21) Appl. No.: 16/468,695

(22) PCT Filed: Dec. 1, 2017
(86) PCT No.: PCT/EP2017/081152

§ 371 Date: Jun. 12, 2019

(30) Foreign Application Priority Data
Dec. 14, 2016 (DE) 10 2016 014 948.5

(51) Int. Cl. B05B 12/14; B05B 13/04; B05B 15/555; B05B 1/30

(52) U.S. Cl. CPC B05B 12/149; B05B 1/3053; B05B 15/555; B05B 13/0452

(57) ABSTRACT

The disclosure concerns a printhead for the application of a coating agent to a component, in particular for painting a vehicle body component with a paint. The disclosure provides that the printhead is designed in such a way that it enables a color change during coating operation and can be rinsed with a rinsing agent during a color change in order to rinse out coating agent residues from the printhead.

### CROSS-REFERENCE TO RELATED APPLICATIONS

This application is a national stage of, and claims priority to, Patent Cooperation Treaty Application No. PCT/EP2017/081152, filed on Dec. 1, 2017, which application claims priority to German Application No. DE 10 2016 014 9483.5, filed on Dec. 14, 2016, which applications are hereby incorporated herein by reference in their entireties.

### BACKGROUND

The disclosure concerns a printhead for the application of a coating agent to a component, in particular for painting a vehicle body component with a paint. The disclosure also includes an operating method for such a printhead.

For the serial coating of vehicle body components, rotary atomizers are usually used as application devices, but these have the disadvantage of limited application efficiency, i.e. only part of the applied paint deposits on the components to be coated, while the rest of the applied paint has to be disposed of as so-called overspray.

A newer development line, on the other hand, provides for so-called printheads as application devices, as known for example from DE 10 2013 002 412 A1, U.S. Pat. No. 9,108,424 B2 and DE 10 2010 019 612 A1. In contrast to the known rotary atomizers, such printheads do not emit a spray of the paint to be applied, but a narrowly confined paint jet, which is almost completely deposited on the component to be painted, so that almost no overspray occurs.

Such printheads have control valves for controlling the release of the coating agent. FIG. 1 shows a schematic representation of such a control valve arranged in a printhead.

Here there is a nozzle opening 2 in a nozzle plate 1, which is either released or blocked by the control valve. In the nozzle plate 1 there are further nozzle openings beside the nozzle opening 2, which are each controlled by a separate control valve, whereby these further nozzle openings are not shown for simplification.

Furthermore, the printhead contains a base plate 3, which confines a coating agent supply 4, i.e. the coating to be coated is supplied via the coating agent supply 4 and can then exit through the nozzle opening 2 when the control valve is open.

A coil tube 5 is arranged on the upper side of the base plate 3 and is wound with a coil 6 on the outside.

In the coil tube 5 there is a magnetic coil core 7, which is fixed and sealed against the coil tube 5 by a seal 8.

In addition, there is a magnetic armature 9 in the coil tube 5, which can also be called a valve needle and can be moved in the direction of the double arrow depending on the current supplied to the coil 6 in order to either release or close the nozzle opening 2.

The armature 9 carries a seal 10 at its lower end to seal the nozzle opening 2 in the shown closed position so that no paint can escape from the nozzle opening 2.

In addition, the control valve has a return spring 11, which pushes the armature 9 and thus also the seal 10 in the drawing downwards into the shown closing position.

To open the control valve, the coil 6 is energised in such a way that the armature 9 with the seal 10 is actively pulled upwards in the drawing against the force of the return spring 11.

To close the control valve, on the other hand, the coil 6 is de-energised so that the return spring 11 can push the armature 9 and thus also the seal 10 in the drawing downwards into the closed position shown.

A disadvantage of this well-known control valve is the fact that the interior of the control valve and especially an interior 12 of the coil tube 5 is exposed to the paint.

On the one hand, paint residues in the interior 12 of the coil tube 5 can therefore impair the functionality of the control valve. For example, paint deposits in the control valve can impair the freedom of movement of the armature 9.

On the other hand, the paint residues in the interior 12 of the coil tube 5 also prevent a colour change, since the control valve cannot be rinsed during operation. The well-known printheads with control valves of this type also offer the possibility of applying a different colour paint.

One possibility is to remove, disassemble, clean and reassemble the control valve, which, however, takes 1-2 hours and therefore prevents a colour change during operation.

Another possibility for a colour change is to rinse the printhead with an extremely high amount of rinsing agent of several litres and over a longer period of several minutes, which also prevents a colour change during operation due to the required amount of rinsing agent and the required rinsing time.

Finally, it is possible to replace the control valve or the complete printhead, but this is also not possible during operation and therefore prevents a colour change.

The known printheads described above therefore do not allow a practical color change during operation.

The technical background of the disclosure can also be found in DE 696 22 407 T2 and DE 36 34 747 A1.

### BRIEF DESCRIPTION OF THE DRAWINGS

FIG. 1 shows a schematic representation of a conventional control valve in a printhead for paint application,

FIG. 2 shows a schematic diagram of the control valve with a rinsing agent supply,

FIG. 3 is a modification of FIG. 2 in which the rinsing agent is supplied via the coating agent supply,

FIG. 4 another modification with a rinsable guide cage for the anchor,

FIG. 5 shows another modification with a rinsable plunger,

FIG. 6 shows a further modification with a rinsing agent supply at the upper end of the coil tube,

FIG. 7 a modification with a flexible diaphragm to separate the control valve from the media carrying channels,

FIG. 8 a schematic representation of an printhead according to the disclosure with an upstream color changer and a return, as well as

FIG. 9 shows a schematic diagram of the supply of several control valves with rinsing agent and coating agent.

### DETAILED DESCRIPTION

The disclosure is therefore based on the task of creating a correspondingly improved printhead and specifying a corresponding operating method.

The disclosure comprises the general technical teaching to design the printhead technically in such a way that a colour change is possible during the coating process. This is achieved by the fact that the printhead can be rinsed with a rinsing agent during a colour change in order to rinse out coating agent residues from the printhead.

In accordance with the state of the art, the printhead according to the disclosure has a coating supply in order to feed the coating to be applied to the printhead. In addition, printhead according to the disclosure preferably also has a separate rinsing agent supply to supply a rinsing agent. It should be mentioned here that the coating agent supply is preferably separated from the rinsing agent supply, so that the printhead preferably has separate inlets for the supply of the coating agent on the one hand and for the supply of the rinsing agent on the other hand.

For a few colors, one color hose (coating agent supply) per color could be connected to the applicator (printhead). Then there is a rinsing agent connection and a pulse air connection in or on the applicator. These are then used for rinsing.

In addition, the printhead according to the disclosure also may have a return system in order to return coating agents and/or rinsing agents, either to a ring line or to disposal. In addition to the separate connections for the supply of the coating agent and the rinsing agent, the printhead in accordance with the disclosure therefore also preferably has a further separate connection in order to return coating agent or rinsing agent.

The return flow to the return system, in one example is controlled by a controllable return valve, which can be designed as a self-actuated return valve or as a proportional valve. Such valve types are known from the state of the art and therefore do not need to be described in detail.

In one example, the printhead has several nozzles to dispense the coating agent. The individual nozzles are preferably each assigned a control valve in order to control the release of coating agent through the respective nozzle. The above mentioned rinsing agent supply then has branch lines leading to the individual control valves so that all control valves of the printhead can be rinsed simultaneously with the rinsing agent.

In one example, the individual branch lines of the rinsing agent supply are y designed in such a way that the rinsing agent supplied is evenly distributed to the branch lines to the control valves, so that the individual control valves are essentially rinsed with the same amount of rinsing agent.

In one example the printhead has at least one nozzle for dispensing the coating agent and an associated control valve for controlling the dispensing of the coating agent through the nozzle, as explained briefly above. The control valve may have an electrical coil, as in the known design described above, which may be wound onto a coil tube. It was already explained at the beginning about the state of the art that coating residues can be deposited in this coil tube, which on the one hand can impair the functionality of the control valve and on the other hand can prevent the colour change capability. Therefore, the rinsing agent supply line of the printhead according to the disclosure preferably flows into the coil tube in order to rinse the inside of the coil tube.

It should be mentioned here that the coil tube—as with the conventional control valve described at the beginning—preferably has a circular internal cross-section and contains a coil core. Here it can be advantageous if the coil core has a profile cross section that does not completely fill the inner cross section of the coil tube in order to leave space for the rinsing agent between the coil tube and the coil core so that the rinsing agent can flow through in the axial direction. For example, the coil core may have a star-shaped profile cross-section with radially projecting ribs running in the axial direction, so that the rinsing agent can flow between the ribs of the coil core in the axial direction.

Alternatively, it is possible for the coil core to have a rinsing groove in its circumferential surface that can run axially, in the circumferential direction or spirally, for example.

In addition, axial rinsing channels can also be arranged in the coil core.

Another example provides that the profile cross-section of the coil core is grid-shaped and can be flowed through by the rinsing agent.

It should also be mentioned that the coil core is preferably sealed against the coil tube with a seal, in particular with a pressure resistance of more than 2 bar, 4 bar or 6 bar.

It has already been briefly mentioned above that the printhead may have several control valves, all of which can be rinsed. The individual control valves usually have one coil tube each, whereby the rinsing agent supply then opens into all coil tubes in order to rinse all coil tubes.

It should also be mentioned that the control valve usually has a movable armature, as in the known control valve described at the beginning, which is moved depending on the current supplied to the coil and closes or releases the nozzle depending on its position.

In one example, this armature runs coaxially on part of its length in the coil tube and preferably has an axially permeable profile cross-section so that rinsing agent can flow between the armature and the inner wall of the coil tube. For this purpose, the armature preferably has a non-circular profile cross-section which does not completely fill the circular internal cross-section of the coil tube and therefore permits axial flow of the rinsing agent. For example, the profile cross-section of the armature can be star-shaped or cross-shaped.

In a variant of the disclosure, the rinsing agent supply opens into the coil tube axially between the armature and the coil core.

In another variant of the disclosure, on the other hand, the rinsing agent supply opens into the coil tube in the axial direction in the area of the coil core, in particular at the end of the nozzle tube remote from the moving armature.

In another variant of the disclosure, the movable armature is arranged in a guide cage permeable to rinsing agent, in particular in a slotted cylinder. This offers the advantage that the movable anchor can be rinsed during a rinsing process, thus avoiding coating deposits on the anchor.

In another variant of the disclosure, the sliding anchor has a central guide hole with a guide pin projecting into the guide hole. This results in a linear guide, which can also be rinsed.

In another example of the disclosure, a flexible diaphragm is provided which separates the control valve from the coating agent supply so that the control valve is protected by the diaphragm against contact with a coating agent. This means that the control valve itself does not have to be rinsed at all, as the control valve itself does not come into contact with the respective coating agent at all. Rather, only the smooth surface of the membrane on the coating agent side should be rinsed, which is, however, very easy and efficient, since the smooth membrane surface hardly forms any starting points for paint deposits.

The printhead according to the disclosure preferably enables a fast color change within a color change time of less than 1 h, 20 min, 10 min, 30 s, 10 s or even less than 5 s.

The aim is to achieve the lowest possible paint change losses, which are preferably smaller than 51, 21, 200 ml, 20 ml, 10 ml, 5 ml or even smaller than 2 ml with the printhead according to the disclosure.

This also leads advantageously to a very low rinsing agent consumption during a colour change, whereby the rinsing agent consumption is preferably smaller than 101, 51, 21, 200 ml, 100 ml, 50 ml, 20 ml or even smaller than 10 ml.

Furthermore, the disclosure allows the printhead to have several separate rinsing agent supplies to supply different rinsing agents, which can be adapted to the respective coating agent, for example.

It should also be mentioned that the printhead with its media-carrying parts is preferably designed in such a way that the media-carrying parts are free of dead space and/or undercutting in order to improve the rinsing capability.

To improve rinsability, it is also possible for the printhead to have a cleaning-enhancing coating on its surfaces that come into contact with the coating agent, whereby such a coating is also known as an “easy-to-clean coating”.

Furthermore, it should be noted that the disclosure does not only claim protection for the printhead according to the disclosure described above as a single component or as a replacement part. Rather, the disclosure also claims protection for a complete coating device with such a printhead.

In addition, the coating device according to the disclosure preferably also includes a color changer, such as a linear color changer, a rotary color changer, a color changer integrated in the printhead or an A/B color changer. These types of color changers are known from the state of the art and therefore do not need to be described further.

Finally, the disclosure also includes a corresponding operating method for such a printhead, whereby the individual process steps already result from the above description and therefore do not need to be described in more detail.

However, it should be mentioned that the rinsing agent can be a universal rinsing agent suitable for both water-based and solvent-based coatings. In addition, the rinsing agent can be a VOC-free (VOC: volatile organic compounds) rinsing agent.

During the rinse process, the printhead can also be rinsed together with the rinse agent or alternately with pulsed air.

It is also possible to supply the printhead with an aerosol for rinsing.

The disclosure also offers the possibility of supplying the printhead with different rinsing agents one after the other.

In a variant of the operating method a solvent-based paint is first supplied and applied. The printhead is then rinsed with a solvent-based rinsing agent to rinse out residues of the solvent-based paint. An optional release agent can then be added, such as alcohol. In the next step, a water-based paint is added and applied. Finally, the printhead is rinsed with a water-paint-based rinsing agent to rinse out residues of the water-based paint.

The above description explains a change from a solvent-based coating paint to a water-based paint. It is also possible to change from a water-based paint to a solvent-based paint, which requires a correspondingly changed sequence of the process steps described above.

After a colour change, the printhead is preferably pre-filled with the new coating agent, i.e. filled. A defined amount of coating agent is preferably applied through the nozzle of the printhead.

When operating the printhead according to the disclosure, there is also the possibility that all fluids (coating agent and rinsing agent) released during a rinsing process can be collected for disposal.

It is also possible to rinse the outer surface of the nozzle head during the colour change in order to remove any residues of coating agent adhering to it.

It should also be mentioned that the rinsing agent can be discharged one after the other or alternately into the return system or through the nozzle. In addition, there is also the option of rinsing with a mixture of rinsing agent and pulsed air.

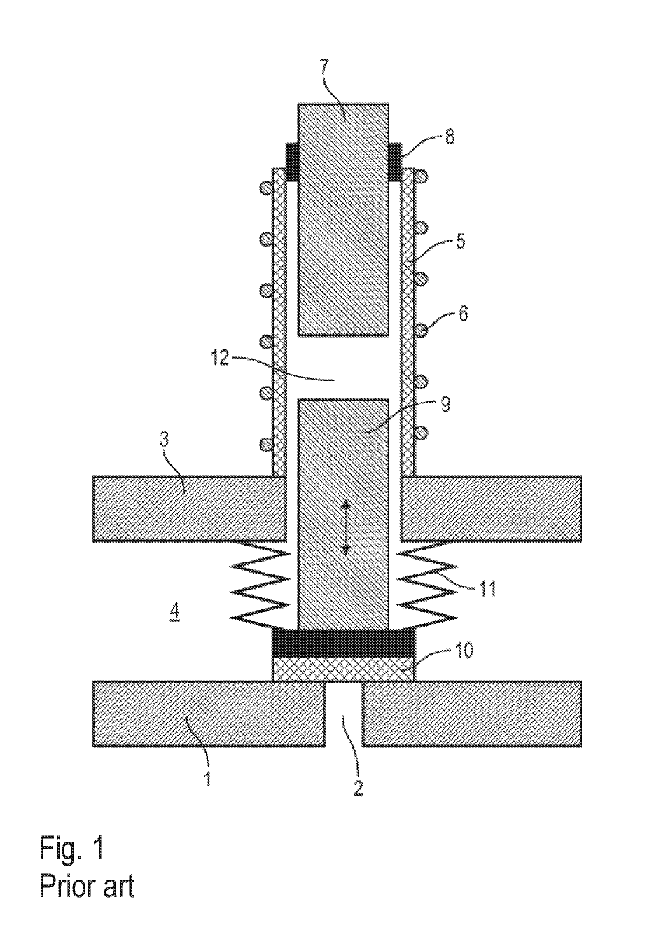

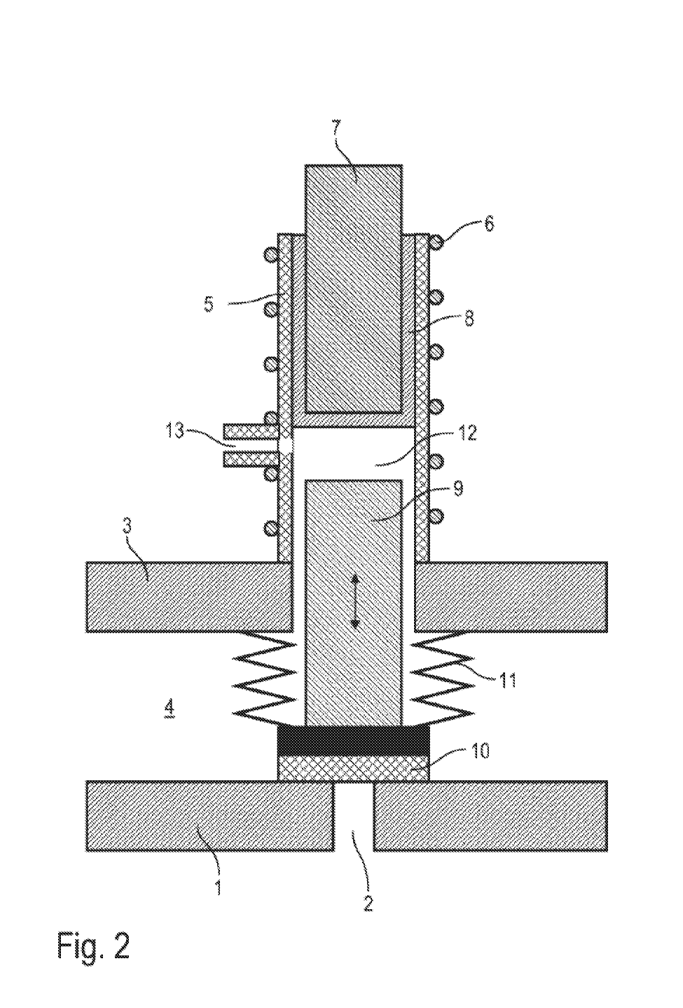

In the following, the schematic representation of a control valve according to the disclosure in FIG. 2 is described, whereby the control valve is arranged in a printhead. This example of a control valve according to the disclosure partly corresponds to the conventional control valve described at the beginning and shown in FIG. 1, so that in order to avoid repetitions the above description is referred to, whereby the same reference signs are used for corresponding details.

A feature of this example is that the control valve has a rinsing agent supply 13 which opens into the interior 12 of the coil tube 5. This rinsing agent supply 13 can therefore be used to supply rinsing agent in order to rinse the control valve with a rinsing agent during a colour change. This makes it possible to change the colour during operation within a short period of time.

In addition, the control valve in this example has a design of the seal 8 between the coil core 7 and the coil tube 5, whereby the seal 8 enables a pressure resistance of more than 2 bar.

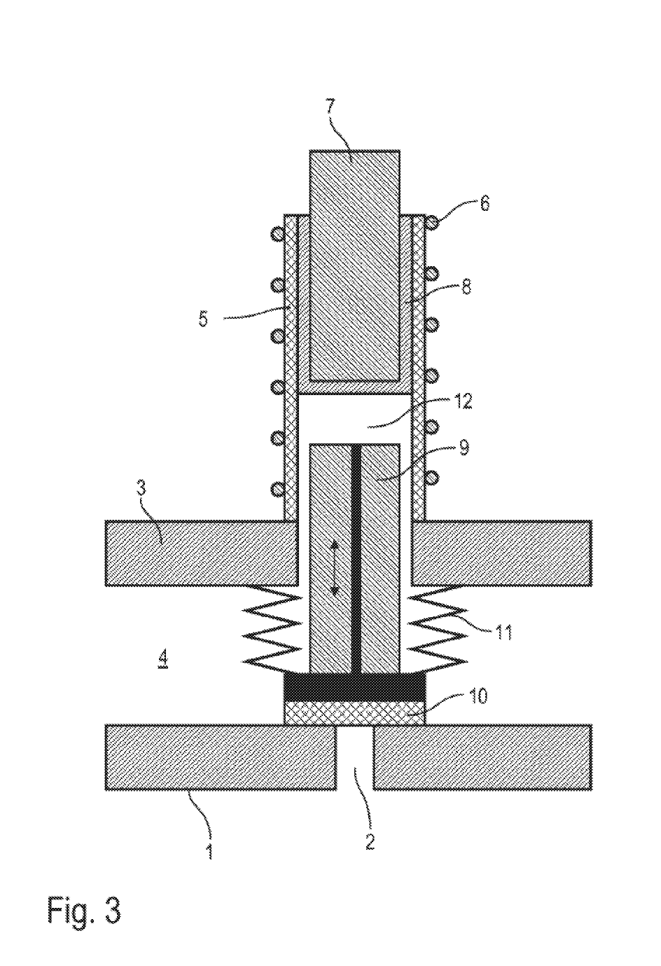

FIG. 3 shows a schematic representation of another design example of a control valve according to the disclosure in a printhead, wherein this example partially corresponds to the above example, so that reference is made to the above description to avoid repetition, using the same reference signs for corresponding details.

A feature of this example is that rinsing agent can flow around the sliding armature 9 freely so that the rinsing agent can also rinse the interior 12 of the coil tube 5. For this purpose, the armature 9 has a cross-shaped profile cross section with axially running ribs, so that the rinsing agent can flow between the ribs of the armature 9 in the axial direction into the interior 12 of the coil tube 5. The rinsing agent is therefore not supplied via the rinsing agent supply 13, as in FIG. 2, but via the coating agent supply 4, which serves alternately for the supply of coating agents and for the supply of rinsing agents. The coil core 7 is sealed against the interior 12 by the seal 8.

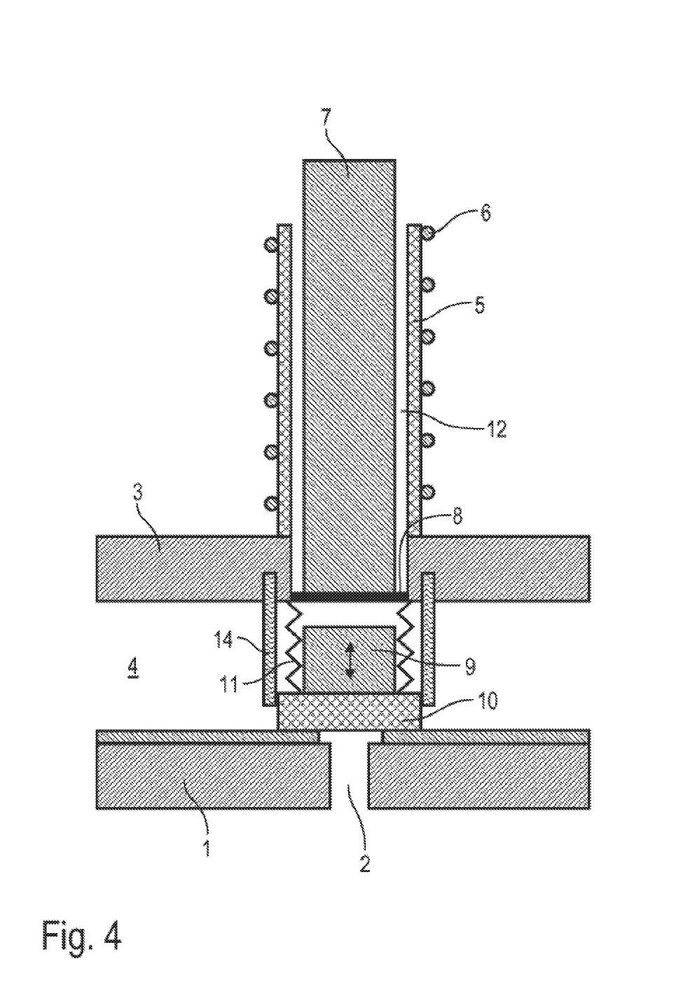

FIG. 4 shows another example, which also largely corresponds to the example described above, so that in order to avoid repetitions, reference is made to the above description, where the same reference signs are used for the corresponding details.

A feature of this example is that the sliding armature 9 is arranged in a rinsable guide cage 14 consisting of a slotted cylinder so that the inside of the guide cage 14 can be rinsed. The seal 8 seals the interior of the coil tube 5 against the media-carrying area.

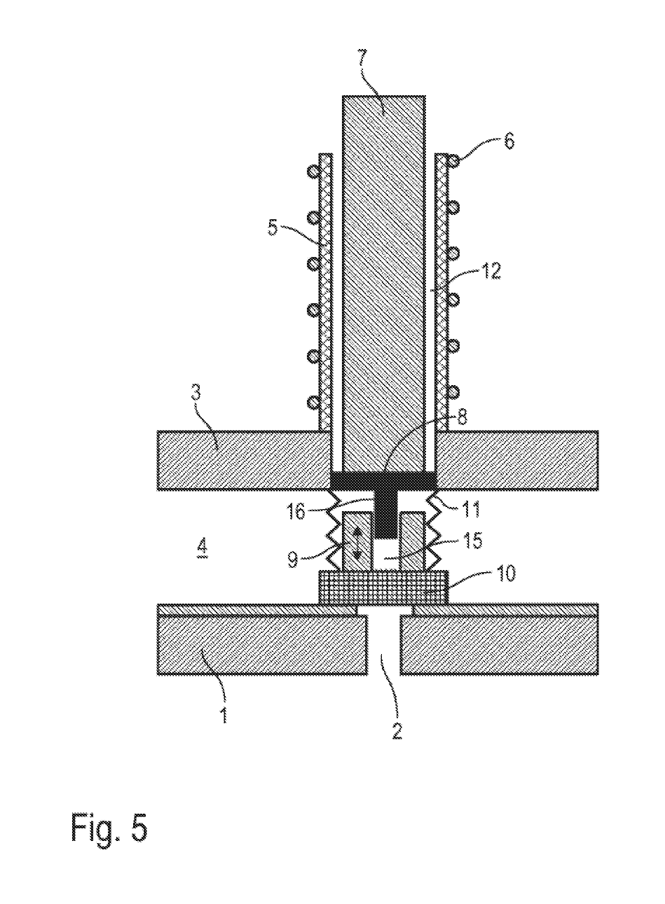

FIG. 5 shows another example, so that the above description is referred to again to avoid repetitions, whereby the same reference signs are used for the corresponding details.

The armature 9 has a central guide hole 15 in which a guide pin 16 engages, whereby the fit of the guide hole 15 and the guide pin 16 is also accessible for rinsing agents.

In addition, the seal 8 seals the annular gap between the coil tube 5 and the coil core 7.

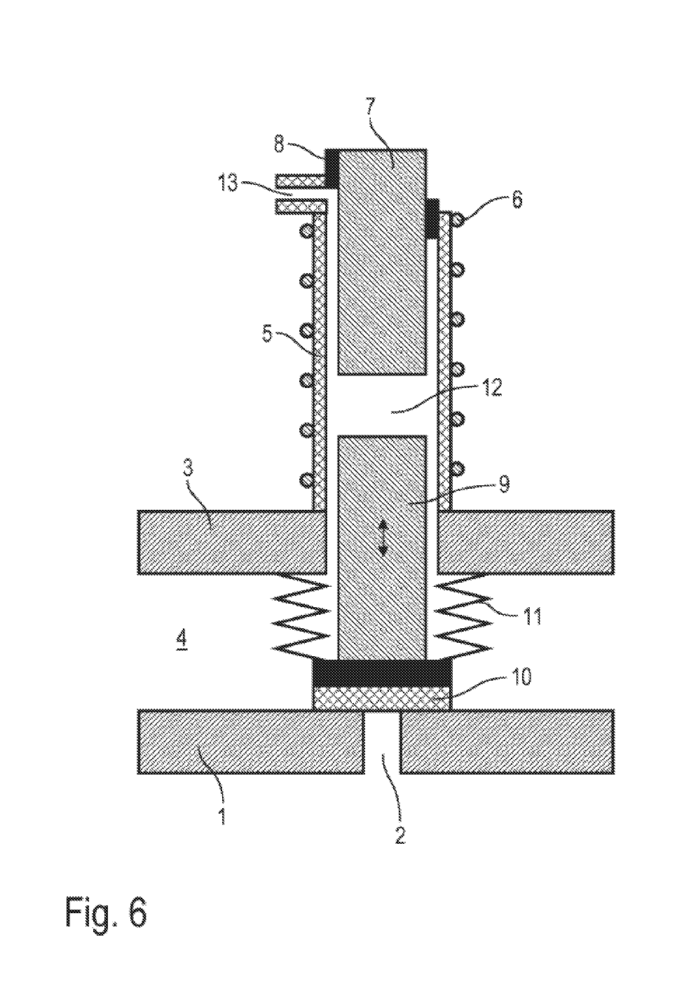

The example shown in FIG. 6 again partly corresponds to the example shown in FIG. 2, so that the above description is referred to avoid repetitions, whereby the same reference signs are used for corresponding details.

A feature of this example is that the rinsing agent supply 13 does not open between the coil core 7 and the armature 9 into the interior 12 of the coil tube. Rather, the rinsing agent supply 13 opens into the coil tube at the upper end of the coil tube 5.

It is noted here that the coil core 7 does not completely fill the free internal cross-section of the coil tube 5, as the rinsing agent can flow downwards from the rinsing agent supply 13 at the top into the interior 12.

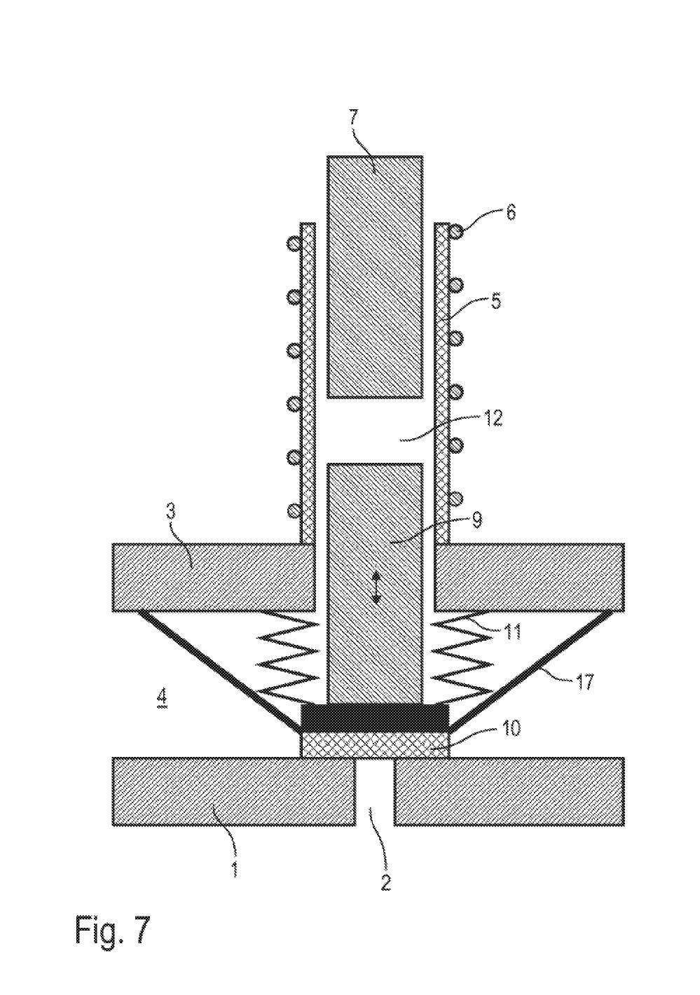

FIG. 7 shows a further modification of a rinsable control valve, which for this purpose provides a flexible diaphragm 17 which separates the control valve from the media-carrying parts in the coating agent supply 4. This means that the control valve itself does not have to be rinsed with rinsing agent, as the control valve itself does not come into contact with the paint at all. Rather, only the diaphragm 17 on its coating agent side is touched by the respective paint, so that only this side of the diaphragm 17 has to be rinsed, which is easily possible by supplying rinsing agent via the coating agent supply.

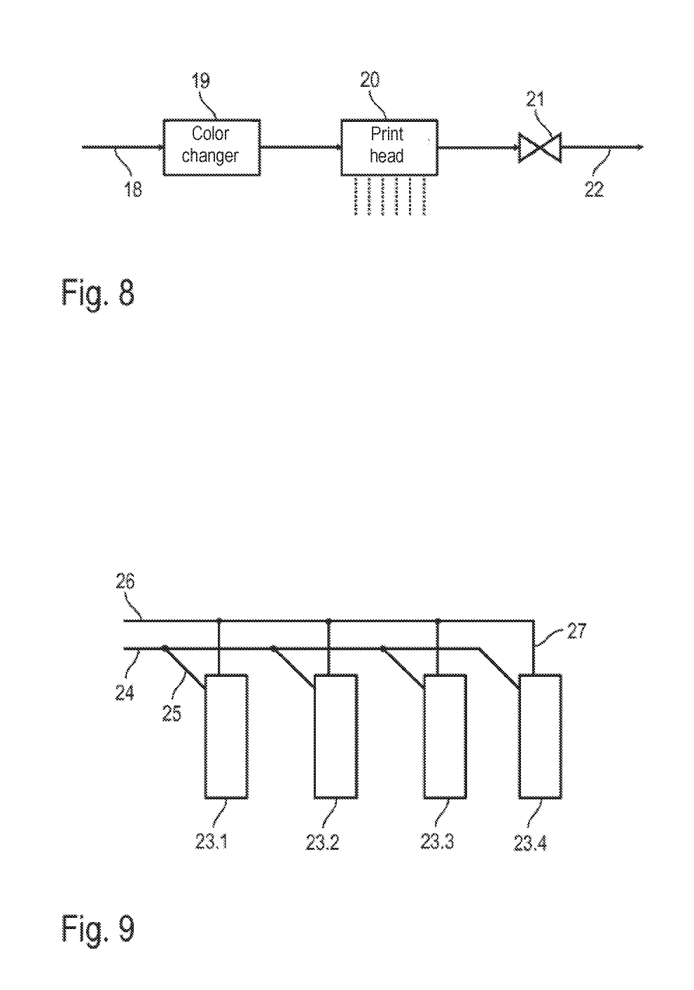

FIG. 8 shows a very simplified schematic representation of a coating device according to the disclosure with a coating agent supply 18, a colour changer 19, a printhead according to the disclosure 20, a return valve 21 and a return 22.

The colour changer 19 can supply the printhead 20 with different coloured coating agents, whereby the printhead 20 can optionally be rinsed with rinsing agent either via a rinsing agent supply (not shown) or via the coating agent supply 18.

Any residues of coating agent and rinsing agent arising during a rinsing process can then be discharged into the return 22.

Finally, FIG. 9 shows a schematic representation of an printhead according to the disclosure with several control valves 23.1, 23.4, which are supplied with coating agent via a common coating agent supply 24 with several branch lines 25.

In addition, the coating device has a common rinsing agent supply 26 which is connected to the individual control valves 23.1-23.4 via one branch line 27 each, so that all control valves 23.1-23.4 of the printhead can be rinsed with rinsing agent.

The disclosure is not limited to the preferred examples described above. Rather, a large number of variants and modifications are possible which also make use of the disclosure idea and therefore fall within the scope of protection.

1.-26. (canceled)

27. Printhead for applying a coating agent to a component, wherein the printhead enables a colour change during coating operation and can be rinsed with a rinsing agent during a colour change in order to rinse out coating agent residues from the printhead.

28. Printhead according to claim 27, further comprising
a coating agent supply for supplying at least one of the coating agent to be applied and the rinsing agent.

29. Printhead according to claim 28, further comprising a separate rinsing agent supply for supplying the rinsing agent.

30. Printhead according to claim 28, characterized by
a) a return system for recirculating at least one of the coating agent and rinsing agent; and
b) a return valve for controlling the return flow into the return system.

31. Printhead according to claim 30, wherein the return valve is a self-actuated return valve.

32. Printhead according to claim 30, wherein the return valve is a proportional valve.

33. Printhead according to claim 28, wherein
a) the printhead comprises a plurality of nozzles for dispensing said coating agent,
b) the printhead has a plurality of control valves associated with the individual nozzles and controlling the release of coating agent through the individual nozzles,
c) the rinsing agent supply has branch lines to the individual control valves so that all the control valves are rinsed with the rinsing agent.

34. Printhead according to claim 33, wherein the branch lines of the rinsing agent supply are designed such that the supplied rinsing agent is evenly distributed among the branch lines to the control valves so that the control valves are rinsed with substantially the same amount of rinsing agent.

35. Printhead according to claim 29, wherein
a) the printhead has at least one nozzle for dispensing the coating agent,
b) the printhead has at least one control valve for controlling the release of coating agent through the at least one nozzle,
c) the control valve has an electric coil,
d) the at least one control valve has a coil tube on which the coil is wound externally,
e) the printhead has a rinsing agent supply for supplying the rinsing agent, and
f) the rinsing agent supply opens into the coil tube and directs the rinsing agent into the interior of the coil tube.

36. Printhead according to claim 35, wherein
a) the coil tube has a circular internal cross-section,
b) the coil tube contains a coil core in its interior.

37. Printhead according to claim 36, wherein the coil core has a profile cross-section which does not completely fill the internal cross-section of the coil tube in order to leave space for the rinsing agent between the coil tube and the coil core.

38. Printhead according to claim 36, wherein the profile cross-section of the coil core is star-shaped.

39. Printhead according to claim 36, wherein the profile cross-section of the coil core has in its circumferential surface at least one rinsing groove.

40. Printhead according to claim 39, wherein the rinsing groove runs axially.

41. Printhead according to claim 39, wherein the rinsing groove runs in circumferential direction.

42. Printhead according to claim 39, wherein the rinsing groove runs spirally.

43. Printhead according to claim 36, wherein the profile cross-section of the coil core has an axially extending rinsing channel.

44. Printhead according to claim 36, wherein the profile cross-section of the coil core is grid-shaped.

45. Printhead according to claim 36, wherein the coil core is sealed with respect to the coil tube by means of a seal.

46. Printhead according to claim 36, wherein
a) the printhead comprises a plurality of coil tubes, and
b) branch lines branch off from the rinsing agent supply into all coil tubes, and.

47. Printhead according to claim 35, wherein the at least one control valve has a displaceable armature which is displaced as a function of the current supplied to the coil and closes or releases the nozzle as a function of its position.

48. Printhead according to claim 47, wherein
a) the armature extends coaxially in the coil tube over part of its length,
b) the armature has an axially permeable profile cross-section in order to be able to pass rinsing agent through between the armature and the inner wall of the coil tube,
c) the anchor has a non-circular profile cross-section in order to leave space for the coating agent.

49. Printhead according to claim 47, wherein the rinsing agent supply opens into the coil tube in axial direction between the armature and the coil core in order to supply the rinsing agent.

50. Printhead according to claim 47, wherein the rinsing agent supply opens into the coil tube in axial direction in the region of the coil core.

51. Printhead according to claim 47, wherein
a) the control valve has a displaceable armature which is displaced as a function of the current applied to the coil and closes or releases the nozzle as a function of its position, and
b) the armature is arranged in a guide cage which is permeable to rinsing agent.

52. Printhead in accordance with claim 47, wherein
a) the displaceable armature has a central guide hole, and
b) a stationary guide pin projects into the guide hole of the movable armature, and
c) the guide hole can be rinsed in the displaceable anchor core.

53. Printhead according to claim 35, further comprising a flexible diaphragm separating the control valve from the coating agent supply so that the control valve is protected by the membrane from contact with the coating agent.

54. Printhead according to claim 29, wherein
a) the printhead allows colour change within a colour change time of less than 30 s,
b) the colour change does not take longer than the infeed or outfeed of the coating object from the painting zone, and
c) the colour change takes place in the time gap given by the distance between two coating objects; and
d) the printhead has small colour change losses during a colour change which are smaller than 51, and
e) the printhead has a low rinsing agent consumption during a colour change which is smaller than 101, and
f) the printhead has a plurality of separate rinsing agent supplies for supplying different rinsing agents.

55. Coating device for coating components, comprising a printhead according to claim 29 for applying the coating agent to the component.

56. Coating device according to claim 55, further comprising a colour changer which is arranged upstream of the printhead and is connected on the output side to the printhead in order to feed the printhead selectively with coating agents of different colours.
